(19) United States
(12) Patent Application Publication
(10) Pub. No.: US 2018/0160034 A1
(43) Pub. Date: Jun. 7, 2018

(54) Dynamic tracking device

(71) Applicant: AMARYLLO INTERNATIONAL B.V., HSINCHU COUNTY (TW)

(72) Inventor: Chao-Tung Yang, Hsinchu County (TW)

(21) Appl. No.: 15/885,976

(22) Filed: Feb. 1, 2018

Related U.S. Application Data
(63) Continuation-in-part of application No. 14/802,745, filed on Jul. 17, 2015.

(51) Int. Cl. H04N 5/232; G06T 7/73; G06T 7/246; H04N 7/18; G06K 9/00

(52) U.S. Cl. CPC H04N 5/23219; G06T 7/74; G06T 7/248; H04N 5/23212; G06T 2207/30232; H04N 5/23229; H04N 7/185; G06K 9/00288; G06T 2207/30201; H04N 5/23222

(57) ABSTRACT

A dynamic tracking device provided in the present disclosure comprises a video recording module, a controller and a rotating module. The controller, which is connected with the video recording module to receive captured images for a target, analyzes pixels distributed on the captured images to detect the target's location and enable the rotating module to be turned. Accordingly, the dynamic tracking device effectuates dynamic surveillance by the controller which analyzes differences of pixels among images shot by the video recording module and enables the rotating module to be turned for tracking a target moving or staying at a location.

This application is a continuation-in-part application of U.S. application Ser. No. 14/802,745 filed on Jul. 17, 2015.

### BACKGROUND OF THE INVENTION

### 1. Field of the Invention

The present invention is related to a tracking device, particularly a tracking device which detects a target moving or staying a location to configure a shooting direction by analyzing differences of pixels distributed on a plurality of captured images.

### 2. Description of the Prior Art

Conventional video tracking systems mainly use the following technical methods to monitor real-time moving objects:

Method 1: The most common solution is to install as many cameras as needed to cover the entire area ensuing no blind spot. This is well seen in most commercial buildings, public facilities, public transportation, private offices, and some residential houses, etc. The issue with this simple solution is the high cost and tedious effort to set up a large number of cameras. Furthermore, because large video contents are recorded, a huge video storage and complicated wiring is needed. A central control room with human operators may be needed if real-time tracking is required.

Method 2: A better solution is to connect the above cameras to a super computer to compare video image frame-by-frame to see if there is any movement or change on the video pixels of each camera. If there is any pixel change, super computer will analyze and provide directional instructions to guide the camera to track the moving objects. The issue with this solution is that the super computer will become more and more expensive as the number of the cameras is increased to the point that the surveillance system is too expensive to be afforded. In no cases, this type of auto-tracking system, which requires a supercomputer to work with multiple remote cameras, is suitable for residential application where cost is the main factor.

In summary, conventional video tracking systems demands a lot of human resources and equipment expenses to achieve the purpose of real-time tracking operations. Accordingly, an affordable tracking device which can automatically execute real-time tracking operation is a technical issue needed to be solved in this technical field.

### SUMMARY OF THE INVENTION

To solve the previous technical problems, the present disclosure is to provide a dynamic tracking device.

To this end, a dynamic tracking device in the present disclosure comprises a video recording module, a controller and a rotating module. The controller is connected with the video recording module by which images for a target are captured; the rotating module is connected with the controller through which the rotating module is configured to be turned based on a shooting direction; the controller, which received images for the target shot by the video recording module, analyzes pixels distributed on the captured images to detect the target's location and enable the rotating module to be turned for the target under dynamic surveillance.

In summary, a dynamic tracking device is competent in real-time surveillance and a shooting direction adjustable dynamically by analyzing pixels distributed on captured images without an external computer or server for convenient configuration and cost reduction compared with a traditional technique which relies on manual operation to regulate a shooting direction.

### BRIEF DESCRIPTION OF THE DRAWINGS

FIG. 1 is a block diagram of a dynamic tracking device.

FIG. 2 is a schematic perspective view of a dynamic tracking device.

FIG. 3 is a schematic view for the operating principle of a dynamic tracking device.

FIG. 4 is a schematic view for operating a dynamic tracking device.

FIG. 5 is a schematic view of a dynamic tracking device monitoring an environment in the fourth embodiment.

FIG. 6 is a schematic view of a dynamic tracking device shooting images in the fifth embodiment.

FIG. 7 is a schematic view of a dynamic tracking device shooting images in the sixth embodiment.

### DETAILED DESCRIPTION OF THE PREFERRED EMBODIMENT

The following descriptions are about embodiments of the present disclosure but not intended to limit the scope of the present invention.

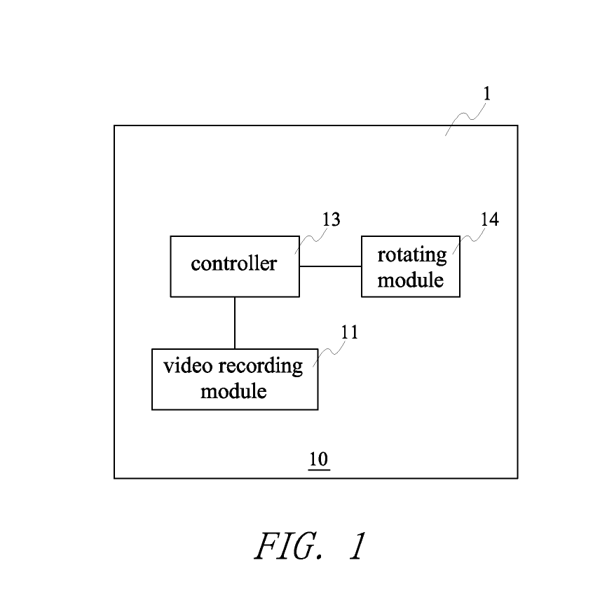

Referring to FIG. 1, which is a block diagram of a dynamic tracking device in the first embodiment. The dynamic tracking device 1 comprises a body 10, a video recording module 11, a controller 13 and a rotating module 14. The controller 13, which is usually an embedded CPU connected with the video recording module 11, analyzes images shot by the connective video recording module 11 and is used to configure a shooting direction of the video recording module 11 for tracking a target; the rotating module 14 is connected with the controller 13 by which the rotating module 14 is configured to rotate based on the shooting direction. In this embodiment, the video recording module 11 is fixedly connected with the body 10 and the rotating module 14 is flexibly connected with the body 10 such that both the body 10 and the video recording module 11 are rotated with the rotating module 14.

The present application further demonstrates a second embodiment, which is similar to the first embodiment but further presents a rotor that is flexibly connected with the video recording module 11 such that the video recording module 11 regulated by the controller 13 is rotated based on a shooting direction.

The present application further demonstrates a third embodiment, which is similar to the first embodiment but further presents a rotor that is fixedly connected with the video recording module 11 and flexibly connected with the body 10 such that the video recording module 11 regulated by the controller 13 makes a rotary movement relative to the body 10 based on a shooting direction.

In structure, the body 10 can be designed as, without limitation, an approximately spherical structure, an approximately cylindrical structure, or a polyhedral structure optionally.

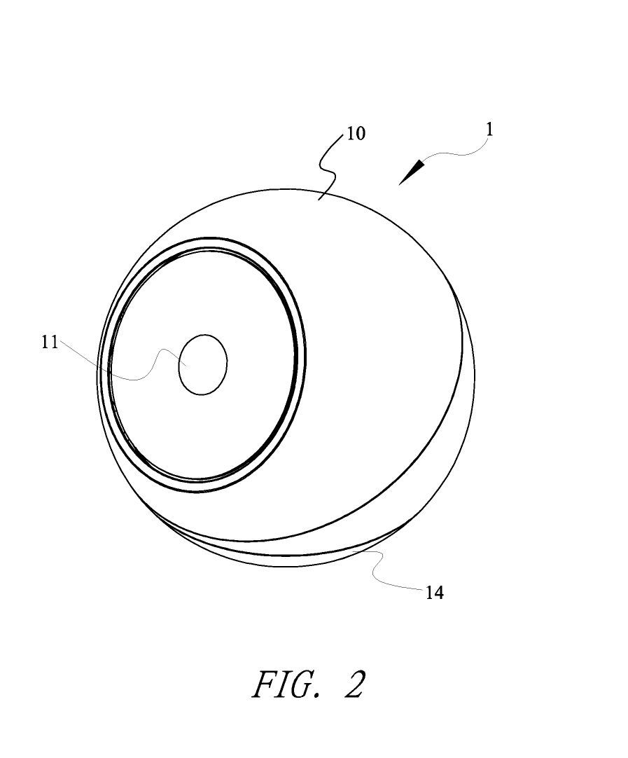

Referring to FIG. 2, which is a schematic perspective view of the dynamic tracking device 1. In this embodiment, the body 10 has an approximately spherical structure on which the rotating module 14 is installed at one end for at least a one-dimensional rotation (left-handed rotation, right-handed rotation, upward rotation or downward rotation). The body 10 comprises a plane partially on which the video recording module 11 is mounted. The rotating module 14 can be a motor device.

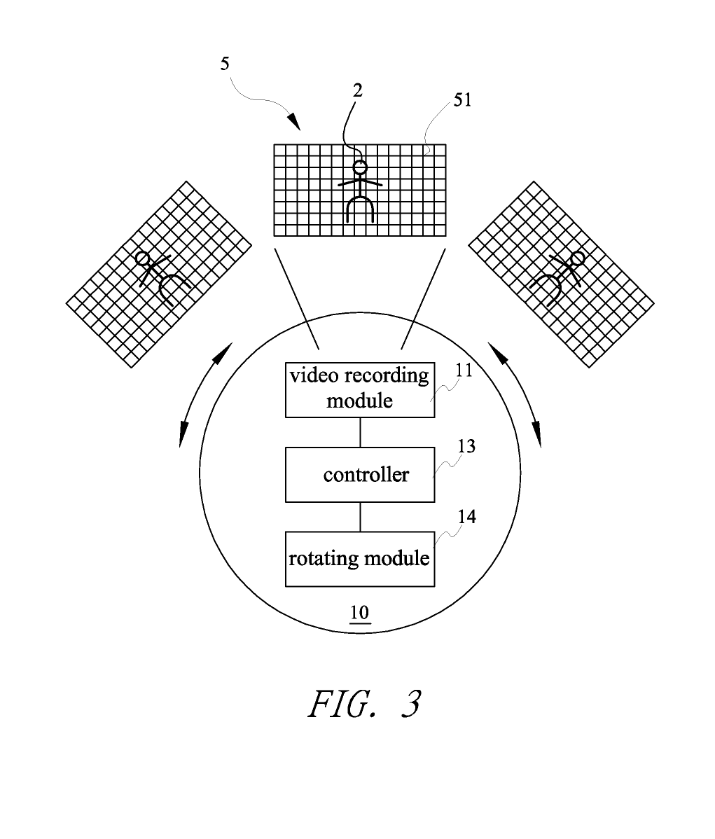

Referring to FIG. 3, which is a schematic view for the operating principle of a dynamic tracking device thereon wherein the video recording module 11 is used to shoot images 5 of a target 2 and the controller 13 analyzing pixels 51 distributed on the images 5 is able to detect a location of the target 2 and enable the rotating module 14 to be turned for the target 2 under dynamic surveillance. With the controller 13 running, the video recording module 11 shoots the target 2 within a certain period of time to capture a plurality of images 5. Then, the controller 13 compares differences of pixels 51 distributed on a plurality of images 5 to recognize the target 2 moving or staying at a location and enable the rotating module 14 to be turned for the target 2 under dynamic surveillance.

The controller 13 further comprises a communications interface through which the captured images 5 are transmitted to an administrator. The communications interface can be a wired communications interface (for example, coaxial cable interface, telephone line interface, network interface or optical fiber interface) or a wireless communications interface (for example, one of various mobile communications network interfaces).

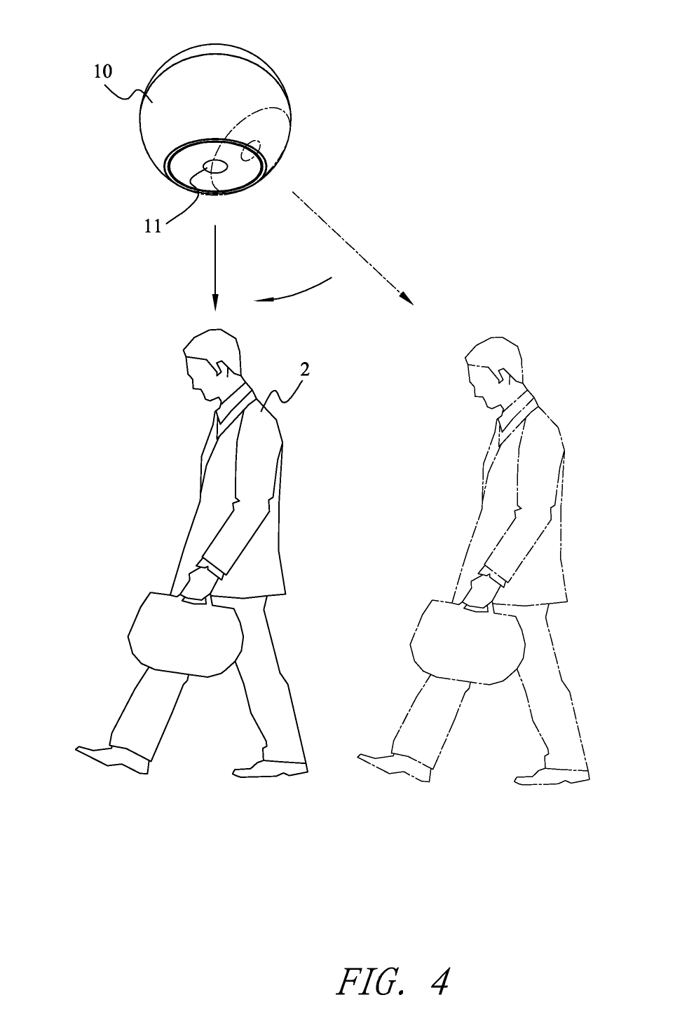

Referring to FIG. 4, which is a schematic view for operating a dynamic tracking device. When the target 2 in the default shooting direction of the video recording module 11 in the dynamic tracking device 1 is monitored, the controller 13 analyzing images 5 for the target 2 shot by the dynamic tracking device 1 can detect the target 2 moving or staying at a location according to comparisons of pixels 51 distributed in a plurality of images 5 and enable the rotating module 14 to be turned for complete dynamic surveillance.

Furthermore, the dynamic tracking device 1 regulated by the controller 13 in a tracking process will aim at the target 2 properly for a better recognition effect.

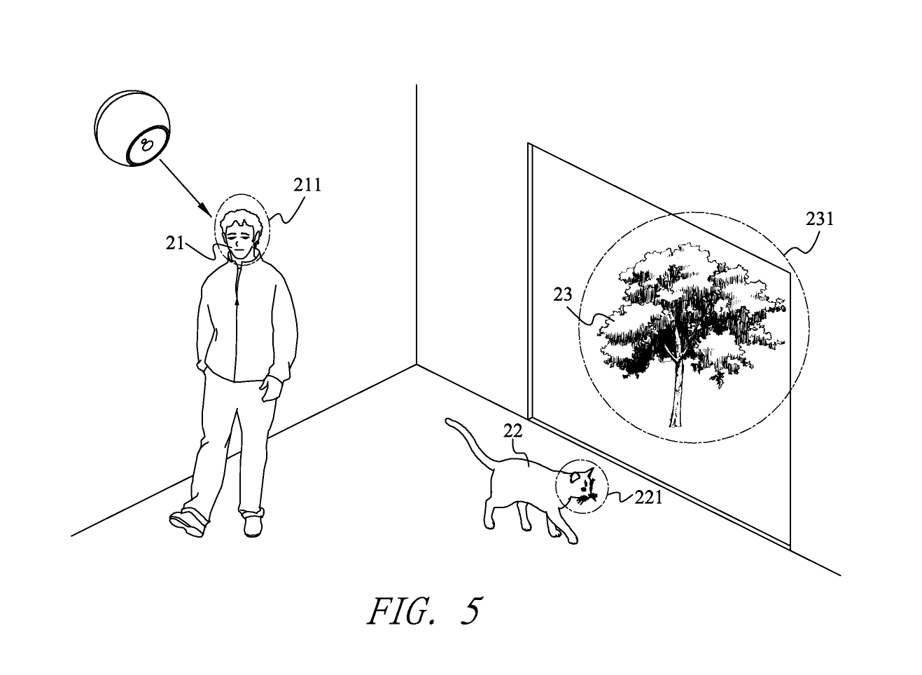

The present application further demonstrates a fourth embodiment, which is similar to the first embodiment but characteristic of the controller 13 which recognizes features of the target 2 at a selected area and decides a type of the target 2 (for example, person, pet or shaky background) in order to activate dynamic surveillance. As shown in FIG. 5 which illustrates a person 21, a pet 22 and a tree 23 erected outside a window and swaying in the wind inside an environment under dynamic surveillance, the controller 13, which is configured to monitor a human being's features at his/her face as the selected area, recognizes facial features in captured images (among a person's facial features 211, a pet's facial features 221 and a tree's features 231 not matching facial features) and activates dynamic surveillance on the person 21 alone without interferences attributed to background noises from a pet 22 or a swaying tree 23).

The present application further demonstrates a fifth embodiment, which is similar to the fourth embodiment but characteristic of a communications interface through which images at a selected area are transmitted to a local database or a remote database for identity recognition and recognized ID information is feedback for setup of dynamic surveillance in the controller 13 based on the recognized ID information. Specially, a checklist for dynamic surveillance and a mechanism for dynamic surveillance, which is shown in but not limited to Table 2, can be set up in the controller 13 from a local or remote device.

TABLE 2

| | | | |
|---|---|---|---|
| ID information | CEO | David Lee | Unknown person |
| Type | Company | Contractor | Intruder |
| information | management | | |
| Tracking | Not tracked | Low | High |
| priority | | | |
| Tracking and | Rotating module: | Rotating module: | Rotating module: |
| recording | low speed/stop | typical | high speed |
| parameters | Video recording | Video recording | Video recording |
| | module: low | module: typical | module: high |
| | resolution | | resolution |

Specifically, the controller 13, which received recognized ID information, will check corresponding type information and dynamic control information by which settings for dynamic surveillance are downloaded.

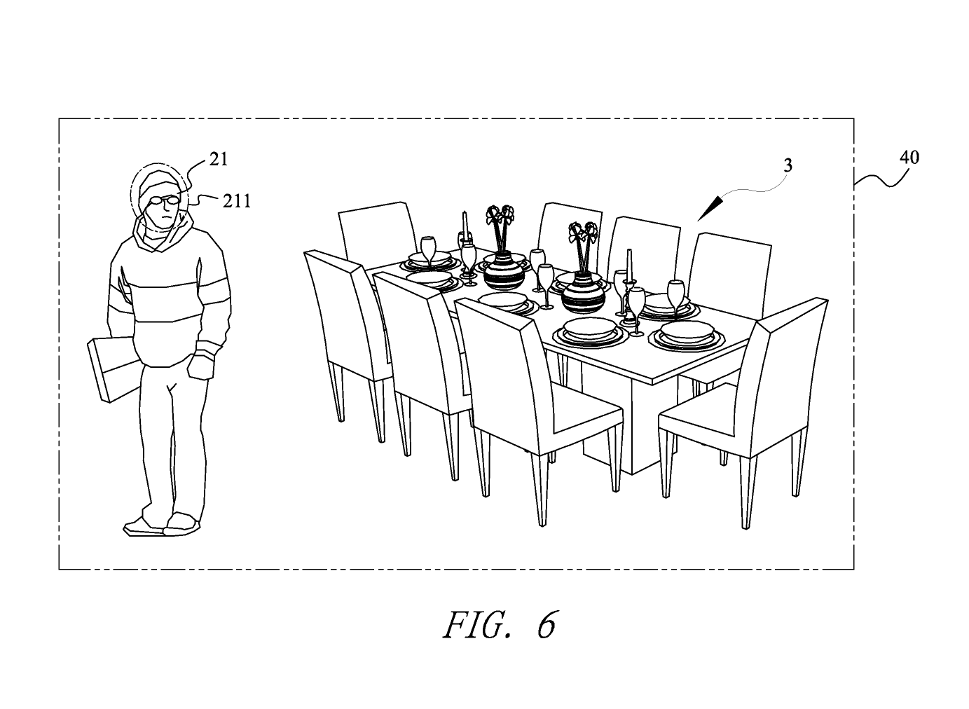

As shown in FIG. 6 for a person 21 detected, the controller 13 depending on a communications interface transmits the person's facial images or facial features 211 to a local database or a remote database in which ID information (content: unknown person), type information (content: intruder) and dynamic control information (content: high-quality dynamic surveillance) for the person 21 are inquired. Furthermore, a surveillance operation is activated in both the rotating module 14 (for high-speed tracking) and the video tracking module 11 (for high-resolution recording) according to dynamic control information.

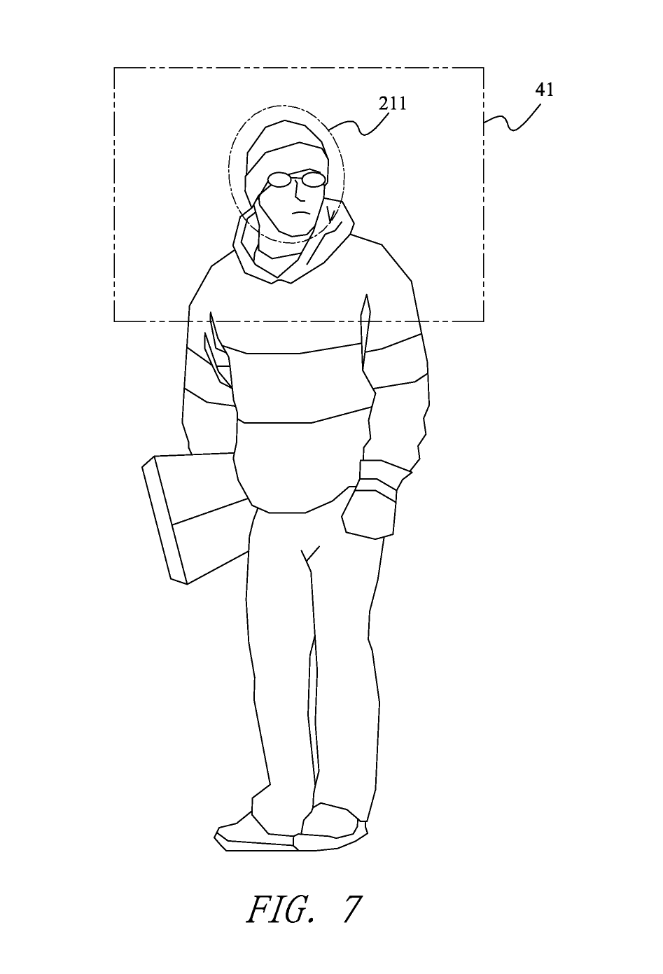

The present application further demonstrates a sixth embodiment, which is similar to the fifth embodiment but characteristic of the controller 13 configuring sharp focusing of the video recording module 11 after determination of a selected area (for example, face) on a target 2 (for example, person 21). As shown in FIG. 6, initial images 40 shot with a wide angle lens and captured by the controller 13 include images of a person 21 and a set of furniture 3. To extract clearer facial features of the person 21, the controller 13 recognizes a selected area (face) in images and configures the video recording module 11 to automatically refocus on and shoot the selected area at the target 2 for an refocused image 41 (as shown in FIG. 7). Accordingly, clearer facial features 211 can be displayed on the refocused image 41 for follow-up image recognition.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A dynamic tracking device, comprising:
a video recording module;
a controller connected with the video recording module and designed as an embedded CPU which analyzes and tracks pixel movements on images; and
a rotating module connected with the controller through which the rotating module is configured to be turned based on a shooting direction;
wherein the controller, which received images for a target shot by the video recording module, analyzes pixels distributed on the captured images to detect the target's location and enable the rotating module to be turned for the target under dynamic surveillance.

2. The dynamic tracking device as claimed in claim 1 wherein the rotating module is flexibly connected with the body of the dynamic tracking device which is rotated with the rotating module for configuring a shooting direction of the video recording module.

3. The dynamic tracking device as claimed in claim 1, further comprising a rotor which is electrically connected with the video recording module such that the video recording module is configured to be turned.

4. The dynamic tracking device as claimed in claim 1 wherein the controller further recognizes a selected area of the target from captured images and determines to configure the rotating module for the target under dynamic surveillance.

5. The dynamic tracking device as claimed in claim 4 wherein the controller further configures the video recording module to automatically focus on and shoot a selected area of the target for a refocused image.

6. The dynamic tracking device as claimed in claim 4 wherein the selected area is a face.

7. The dynamic tracking device as claimed in claim 4 wherein the controller further makes a query to identification information related to the selected area and activates corresponding dynamic surveillance based on the query result.
